(19) United States
(12) Patent Application Publication
(10) Pub. No.: US 2022/0355327 A1
(43) Pub. Date: Nov. 10, 2022

(54) APPARATUS FOR APPLYING PAINT ON MAINLY FLAT PARTS

(71) Applicant: CEFLA SOCIETA' COOPERATIVA, Imola (IT)

(72) Inventors: Cristian PUNGETTI, Ozzano dell'Emilia (IT); Angelo CARRIERO, Zola Predosa (IT); Stefano CHIARINI, Conselice (IT); Samuel MONTEFIORI, Imola (IT)

(21) Appl. No.: 17/621,419

(22) PCT Filed: Jun. 22, 2020
(86) PCT No.: PCT/IB2020/055870

§ 371 Date: Dec. 21, 2021

(30) Foreign Application Priority Data
Jun. 21, 2019 (IT) 102019000009714

(51) Int. Cl. B05B 13/04; B05B 15/52; B05B 15/68; B05B 16/00; B08B 1/00; B08B 1/04

(52) U.S. Cl. CPC B05B 13/0426; B05B 15/52; B05B 15/68; B05B 16/95; B08B 1/002; B08B 1/04; B05B 14/43

(57) ABSTRACT

Apparatus (1) for applying paint comprises a device (40) for applying paint that comprises a plurality of spray guns (26) that is movable along a closed path having two parallel sides connected by two circular arcs, a rotating joint (43) for supplying paint provided with a distributor and comprising a plurality of tube-support chains (44), each tube support chain (44) connecting the distributor of the one rotating joint (43) for dispensing the painting product to a respective gun of said spray guns (26), in which each tube support chain (44) has an inverted U-shape provided with two ends, of which—the first end is connected to a first rotating support (61), which is connected to the rotating joint (43) and follows a circular trajectory, while—the second end is connected to a second rotating support (62), which is connected to a support arm (41) of a respective gun (26) and follows in use the trajectory defined by said closed path.

The present invention relates to the technical field of apparatuses for applying paint to mainly flat products (panels), known on the market as automatic sprayers. In particular, the present invention relates to a particularly advantageous shape of plenum, characterized by an M-shape, and to different advantageous forms of the support for spray guns. A preferred embodiment of the invention refers to the advantageous combination of said M-shaped plenum and to a particular form of the support for spray guns, in particular to a rotating device having an oval shape having the two long sides parallel to one another and perpendicular to the feeding directions of the parts to be painted.

In this context, plenum means a ceiling or upper wall that is able to distribute an airflow entering the closed space of the booth while painting takes place. Fans force air into the booth, the fans can be adjusted in order to vary the speed and the quantity of air input into the spray booth in the time unit. The distribution of air must be as uniform as possible and the air speed must be controlled. In different points of the plenum the dispensed airflow can vary, while it must be constant over time in that specific point. The adjustment of inlet fans is intended to compensate the pressure drop, so that the distribution of air to the plenum is maintained within optimum pre-set limits.

Spray booths are known that through automatic devices (reciprocators, carousels, rotating arms) apply spray paint to products to be painted.

Spray paint application entails not all the sprayed paint hitting the product; the paint not applied to the product partly hits the product conveying system, and partly hovers in the air inside the spray booth itself. This last portion of sprayed paint is called overspray, and is partially intercepted by a suction plant with which the spray booth is equipped.

Non-intercepted overspray tends to contaminate spray booth internal walls, gathering on them up to the point of compromising manufacturing quality, and leading to a significant quantity of painted products being rejected. This thus makes costly cleaning/maintenance of the spray booth itself obligatory.

The overspray intercepted by the suction plant is channelled towards spray booth filters, thanks especially to an airflow generated by the suction plant itself. In this path, the overspray is controlled in a more orderly manner owing to the emission of an airflow from the plenum.

FR2405758 of Manuel Garcia Sanchez discloses a mobile roof for a spray painting booth. This booth is provided for the manual painting of motor vehicles, performed by a human operator. Said roof, which is a filtering ceiling, not a plenum, has three portions, a central portion 2, and two side sectors 3 and 4 which rise in an opposite direction; in other words, overall the ceiling has a convex shape. Said ceiling can move vertically, i.e. rise and lower, in response to the pressure conditions that form inside the booth itself, in order to prevent explosions due to the paints and fuel of the motor vehicles painted inside the booth.

JP2002128578A of Tono Yogyo KK and GB1393202A of Atlas Copco AB describe a rotating support for spray guns. The rotating support is moved along two parallel, rectilinear paths joined by two half-circles. This allows a plurality of guns to be obtained spraying at the same time in a direction perpendicular to the items to be painted in transit.

The present invention seeks to provide a spray booth having a plenum with an improved air circulation in the booth in order to control as much as possible the phenomenon of overspray. This can be obtained generating an airflow more similar to the geometry of the vortex generated by the combined effect of the spray guns and of the suction.

This object is obtained with an apparatus having the features of the independent claims. Advantageous embodiments and refinements are specified in claims appended thereto.

The object is obtained with a spray booth according to the present invention, which has an M-shaped plenum, i.e. a plenum with the central portion lower than the immediately adjacent lateral portions; more peripherally, the plenum lowers again, reaching two end points that are lower than the central portion.

In the preferred embodiment, in the spray booth a rotating device is also present in which the spray guns follow a closed oval path, provided with two parallel sides and two half-circles. This device supports spray guns and can be moved vertically, moving to/away from the object to be painted. Each arm is provided with a distributor block supplying the gun; this distributor block allows the painting product to recirculate.

The M-shape of the plenum forms two expansion chambers in which the kinetic energy of the paint dispensed by the gun is spontaneously and progressively reduced: this allows the suction plant to intercept the overspray.

The apparatus according to the present invention has very high productivity combined with a quality of painted items that is just as high. Indicatively, the speed of transit of the items to be painted can range from 8 to 20 m/min, while the weight of paint applicable to said items ranges from 80 to 300 g/m². The apparatus can work over three work shifts, i.e. 24/24 h.

The advantages of the present invention are due to the improvement in the control of overspray flow. This has several consequences:
cleaner painting process, which, for the final user, translates into a smaller quantity of rejected painted items;
less need for cleaning and maintenance of the spray booth;
lower consumption of air suction plant to get overspray control (lower number of air renewals per time unit) than with other solutions with the same productive potential;
recovery of a higher quantity of paint by the auto-cleaning conveyor, in the cases in which the paint is suitable for being re-utilized. Experimentally, it was shown that the plenum according to the present invention allows 15% more paint to be recovered than with a paint booth of the known art produced by the same applicant, having a flat plenum.

With respect to the rotating spray gun support, provided with an oval shape with two parallel sides, the advantages are connected to the following features:
The pathway of the spray guns provided with two parallel sides and two joining half-circles can be followed in both directions, clockwise and anti-clockwise;
The position of the spray guns with respect to the parts to be painted transiting underneath can be height-adjusted, in other words, the spray guns can be moved towards or away from the items to be painted;
Paint recirculation occurs in the top portion of the spray gun support, and therefore in the portion protected from overspray; in the lower part there are only the arms supporting said spray guns, which eases cleaning;
The oval rotating gun support is provided with a cleaning device that allows an automatic cleaning cycle of all the guns present on the gun support to be performed.

The present invention will be disclosed below in one of the embodiments thereof with the help of the following figures, which show:

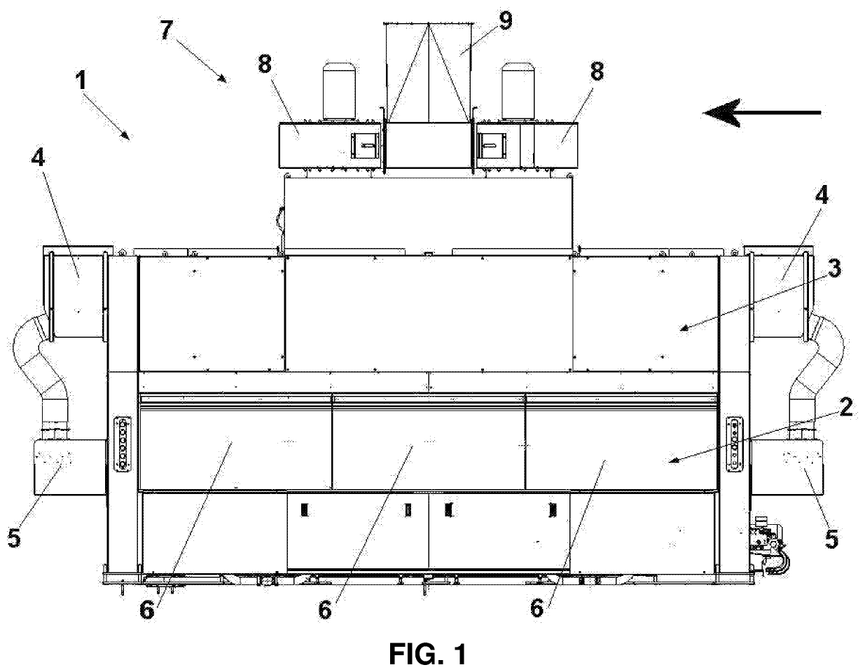

FIG. 1 Lateral view of an apparatus according to the present invention;

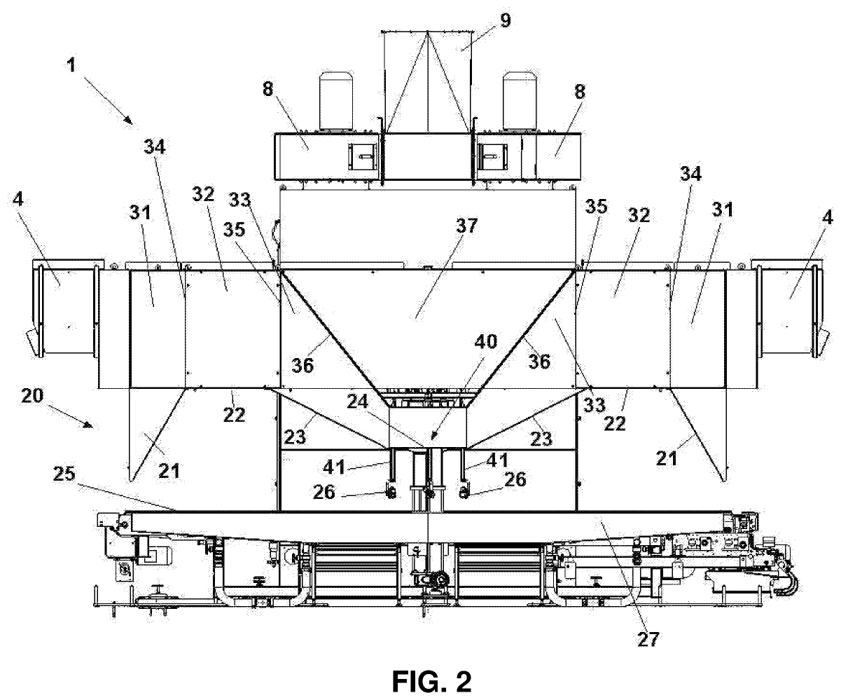

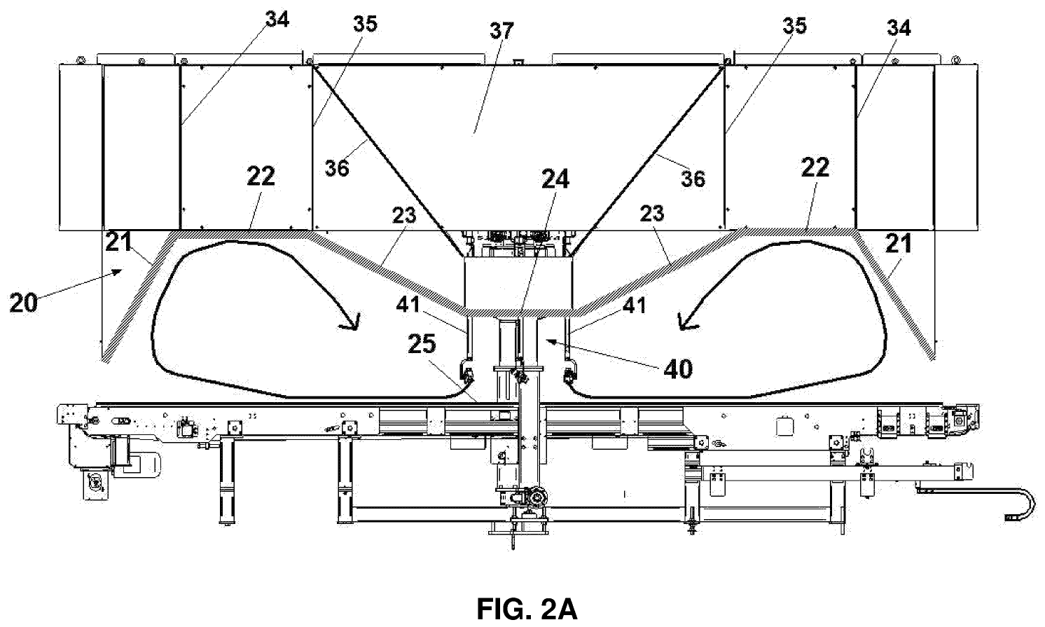

FIG. 2 Lateral section of an apparatus according to the present invention;

FIG. 2A Detail of the preceding lateral section;

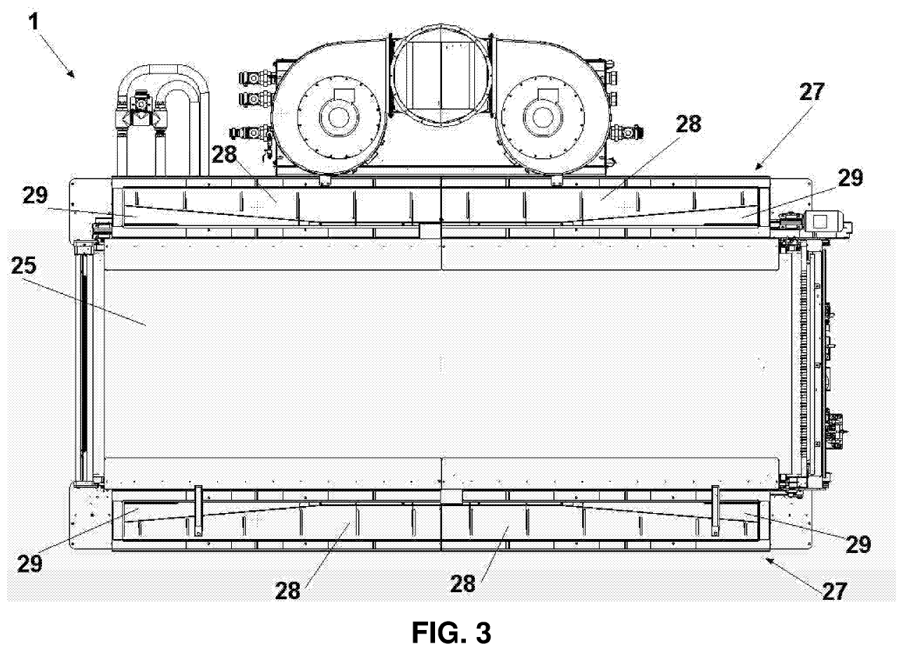

FIG. 3 Top view of an apparatus according to the present invention in a section performed below the spray guns;

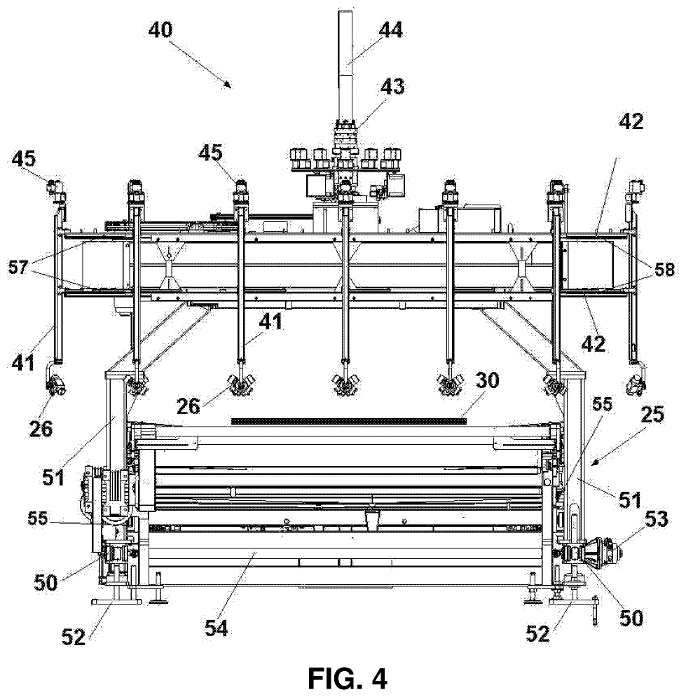

FIG. 4 Detail of the oval rotating device, seen from the inlet of the apparatus, front view;

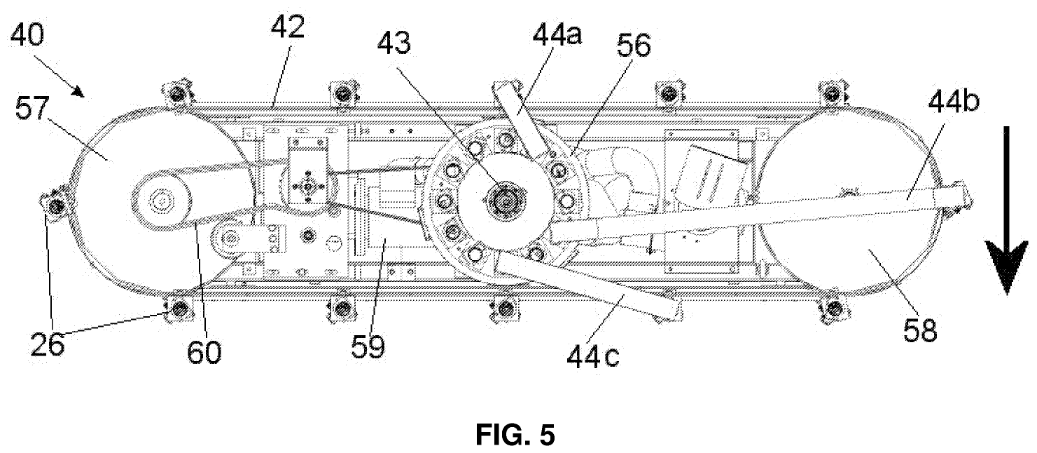

FIG. 5 Detail of the oval rotating device, top view;

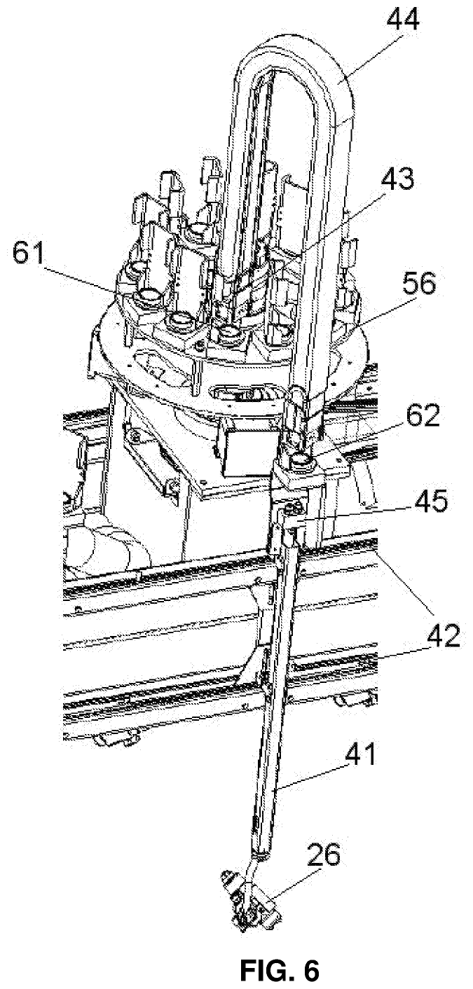

FIG. 6 Detail of a portion of the oval rotating device, axonometric view;

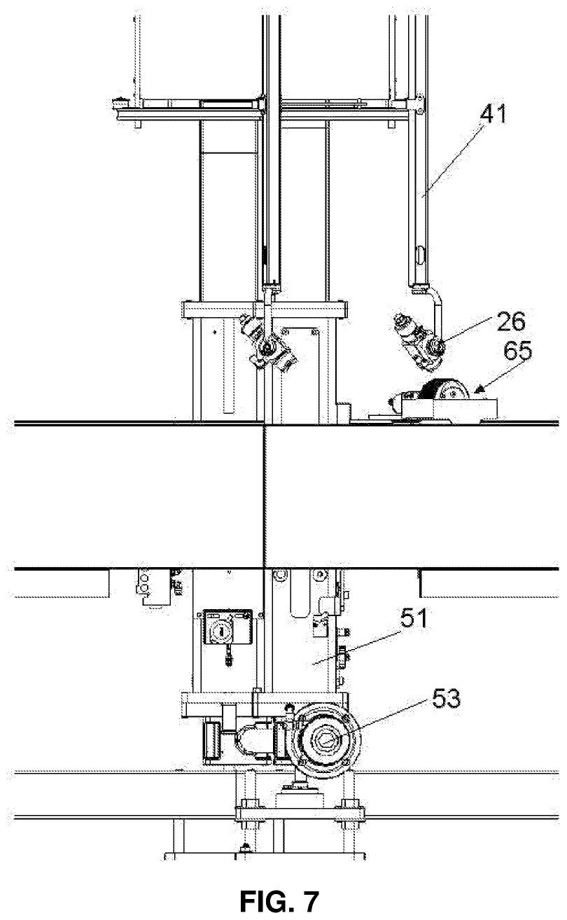

FIG. 7 Detail of the oval rotating device in a lateral view, orthogonal to the view shown in FIG. 4;

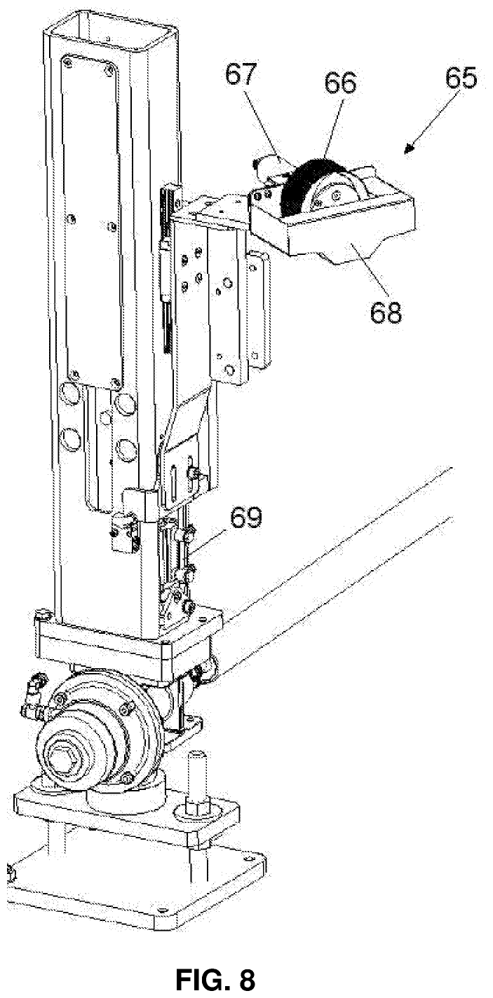

FIG. 8 Detail of the cleaning device, axonometric view.

FIG. 1 shows an apparatus 1 according to the present invention. The direction of the parts to be painted is shown by the bold arrow. A spray booth 2, a series of chambers generically indicated with 3 that are above said spray booth 2, two air inlet groups 4, and two air inlet hoods 5 are visible. The booth 2 is provided with transparent protections 6, which can be opened to access the spraying area, and a tower 7 for washing the air, in order to separate the overspray from the air crossing the apparatus. Said tower 7 is provided with two suction fans 8 releasing the air coming from the spraying booth 2 into the environment through an exhaust flue 9. The portion of the apparatus 1 in which the paint spraying occurs (spray booth 2) is at said protections 6.

It is worthwhile pointing out that, for particular applications, the air inlet groups 4 can be absent, replaced by alternative groups having the same function but providing hyper-filtered air.

FIG. 2 shows a lateral section of the apparatus 1 according to the present invention. In the preferred embodiment, a rotating device 40 follows the oval pathway thereof under the central parallel portion 24, while the guns 26 move away and closer with respect to an observer placed on the side of the apparatus 1. In other words, from the apparatus 1 side the shorter oval side is observed. The (longitudinal) greater axis of the oval is perpendicular to the feeding direction of the items to be painted.

FIG. 2A also shows a lateral section of the apparatus 1 according to the present invention, but in a simplified version. The grey highlighting allows the M-shape of the plenum 20 to be appreciated, in the centre of which there is the rotating device 40. Moreover, FIG. 2A allows the overspray movement to be appreciated, shown by the two spiral arrows under the M-shaped plenum.

From the periphery of the apparatus toward the centre, said plenum 20 has two first external descending portions 21 tilted toward the periphery, which do not touch a conveying belt 25 to permit the transit of the products to be painted. Following said portions 21, there are two lateral surface portions 22, parallel to the conveying belt 25 conveying the parts. Therefrom, there are provided two tilted central surface portions 23, descending towards the rotating device 40 (therefore, having a tilt opposite the first portions 21). The two central descending portions 23 are connected through a parallel central portion 24 which is parallel to the conveying belt 25, and is placed lower (i.e. nearer the conveying belt 25) than the parallel lateral portions 22. The M-shaped plenum 20 is symmetric, and the structure that has just been disclosed of the portions 21, 22, 23, 24 is identical on the two sides. The various surface portions 21, 22, 23 and 24 will be indicated simply as “portions” hereinafter.

It is worthwhile noting that the air exiting the various portions 21, 22, 23, 24 of the plenum always exits perpendicularly to each surface 21, 22, 23, 24.

The speed of the air exiting the descending external portions 21 is such as to contrast the residual kinetic energy of the paint dispensed by spray guns 26, so that the overspray tends to recirculate towards the lateral parallel portion 22, to be then suctioned by the suction plant.

In the portions 22 and 23 of the plenum the exit speed of air exiting the surface of said plenum can be lower than that of the air exiting the portion 21, because they are in a zone in which the kinetic energy of the overspray is lower. The reduction of speed of the inlet air in the areas underneath the portions 22 and 23 of said plenum allows to an overall airflow to be obtained that is lower than in the apparatuses in which the air speed exiting the plenum is homogeneous for all the portions 22, 23, 34, air speed being equal to the airflow of portion 21.

Also in said central parallel portion 24 of the plenum there is an airflow exiting said plenum 20 that has the function of preventing that overspray generated by spray guns 26 dirtying the spray guns 26 themselves and the support arms 41 thereof.

The choking of the air speed in the different portions 21, 22, 23, 24 of the plenum is achieved by controlling the airflow delivered to the spray both by fans 4, adjusting the airflow itself through separating baffles 34, 35, which bound the chambers 31, 32, 33 of the plenum itself. Owing to the presence of the chambers 31, 32, 33 formed by the respective separating baffles 34, 35, just two inlet air groups can be used, placed on the respective sides of the apparatus 1. By modifying the crossing surface of the separating baffles 34, 35 the airflow in the different portions 21, 22, 23 24 of the plenum can be varied, so adjusting also the speed of the air entering the spray booth 2.

It is worthwhile noting that two walls 36 bound the volume in which air is moved. Said walls 36 delimit a volume 37, inside which the rotating device 40 is placed, and into which no forced air is conveyed.

For the sake of clarity, the portion indicated with 3 in FIG. 1 comprises the chambers 31, 32, 33. The volume 37 is not supplied with forced air.

In an alternative embodiment that is not shown, the separating baffles 34, 35 are not perpendicular to the ground as in the Figures, but can be tilted, or have a different extent, or have a different degree of permeability.

The filtration system is provided in the form of lateral suction tanks 27, better observable in FIG. 3. Said lateral suction tanks 27 collect a first portion of overspray, the one provided with lower speed, whereas the overspray vortex indicated with the spiral arrow visible in FIG. 2a, which forms under the external descending portion 21, lateral parallel portion 23 and central descending portion 23, allows the progressive slowing down of the overspray, allowing the suction plant to capture a second portion of slowed down overspray subsequently.

The dimensions and the shape of the plenum 20 represent the best compromise between the overall dimensions of the apparatus 1 on the one hand, and on the other hand the speed and quantity of air needed for containing the overspray, preventing the generation of paint accumulation inside the apparatus. In other words, a bigger apparatus would spontaneously lead to a lower overspray accumulation, but would be too cumbersome and too expensive to find a place in a production line. Indicatively, the dimensions of the spray booth 2 are 3.5 m×6.5 m, with a distance of 1.5 m between parallel lateral portion 22 and conveying belt 25.

FIG. 3 shows a top view of a section performed on a horizontal plane immediately above the conveying belt 25. The Figure shows said suction tanks 27, which are compliant with prior known art. Two tanks 27 are adjacent to the conveying belt 25, provided with a length equal to the length of the conveying belt 25 itself (upper outward section). The conveying belt 25 is a known closed belt conveyor moved by a motorized roller and an idle roller. Said tanks 27 are in the form of tilted planes 28 on which water flows, so that surfaces are kept clean. This water falls into the channel 29 for air suction and water conveying. The channel 29 has a passage section larger in the peripheral portions of the apparatus, and narrower in the central portions of the apparatus, so that the suction speed is kept constant at the sides of the conveying belt 25.

Said tanks 27 are a known water filtration system. Alternatively, this water filtration system can be replaced by a dry filtration system, known in the prior art, too, or alternatively by other filtration systems or paint/air separation systems known in the prior art.

Experimentally, the best performance of the apparatus according to the present invention are obtained by combining the M-shaped plenum 20 with an oval rotating device 40, which combination is the preferred embodiment. Nonetheless, providing an apparatus provided with the oval rotating device (40) without M-shaped plenum, i.e. combined with a known plenum, is possible.

The M-shaped plenum 20 can also be combined with spraying devices of different shape, e.g. a rotating carousel in which the spray guns follow a circular path, or any configuration of a spraying device in which the spraying direction goes from the centre to the periphery of the apparatus. For example, in an alternative not shown embodiment, the same M-shaped plenum 20 can be used combined with spray guns placed in the centre of the apparatus that guns move with a rectilinear alternating movement along a direction orthogonal to the conveying direction of the products 30 to be painted, with a direction so that the paint jet goes from the centre of the apparatus to the periphery.

FIG. 4 shows a detail of the rotating device 40, seen from the entry of the products to be painted. Said device 40 is provided with a plurality of spray guns 26, preferably twelve or twenty-four guns. Each spray gun 26 is supported by a suitable support 41, connecting the gun 26 to a pair of moving chains 42. In this Figure, for the sake of simplicity, only one tube-support chain 44 is shown, of which more details are given below.

FIG. 5 shows the same rotating device 40 seen from the top. Such view allows the oval shape of the moving chains 42 to be appreciated, which is provided with two parallel long sides connected by two half-circle portions.

The spray gun supports 41 are supported by the pair of moving chains 42 which move along the oval trajectory of the guns between a pair of motorized sprocket wheels 57 and a pair of idle sprocket wheels 58 (both visible in FIG. 4). The pair of motorized sprocket wheels 57 is moved by an electric gearmotor 59 through a chain transmission 60.

FIG. 6 shows a detail of a spray gun 26 fixed on its spray gun support arm 41, supported by two moving chains 42.

Each tube-support chain 44 contains the pipes supplying and removing paint for each gun 26. The two ends of each tube-support chain 44 are fixed:
The first end is fixed to a first rotating support 61, which in turn is fixed to a rotating disc 56;
The second end is fixed to a second rotating support 62, which in turn is fixed to the spray gun support arm 41, which in turn is fixed to the moving chains 42.

The two rotating supports 61 and 62, which are constructively identical, allow the rotation of the two ends of the tube-support chain 44, allowing the two ends to move always on the same plan, preventing mechanical warping which would lead to breakage thereof. In fact, the rotating disc 56 is in phase with moving chains 42, i.e. a full circle of the rotating disc 56 corresponds to a full circle of the moving chains 42.

In order to understand the operation of the oval rotating device 40, the three FIGS. 4, 5 and 6 should be considered together.

The same gearmotor 59, again with a chain transmission, moves the disc 56 too, which moves the first end 61 of the tube-support chain 44 and a rotating joint 43.

Said rotating joint 43 (visible also in FIG. 6) is used for supplying the spray guns 26; the operation thereof is explained in detail in document EP3278881B1 of the same applicant.

The rectilinear tracts of the oval rotating device 40 are perpendicular to the feeding direction of the parts to be painted, indicated by the bold arrow in FIG. 5; said rectilinear tracts represent the working portions of the trajectory, i.e. the portions in which the spray guns 26 spray paint on the products 30 to be painted transiting underneath. In the two connecting arc portions, the supply of paint by spray guns 26 is interrupted. This configuration of the moving chains 42 allows two spraying sections to be obtained in which a sequence of spray guns 26 is present allowing a great flow of paint to be sprayed on the transiting products 30. In order to obtain the needed quantity of dispensed paint, arranging a suitable number of spray guns along the trajectory is sufficient. For the application field of the present apparatus, the optimum number of spray guns is twelve: obviously, the skilled person can adjust the number of spray guns according to the quantity of paint to be supplied and to the speed of the transiting items. Obviously, the speed of translation of spray guns 26 can be adjusted to be harmonized to the speed of the products 30 to be painted.

Through supply pipes and a supply pump (which are not shown), the painting product is sent from the storage reservoirs (which are not shown), placed outside the apparatus 1 to the rotating joint 43 placed at the centre of the rotating device 40. From a distributor that is not shown connected to said rotating joint 43 the supply pipes (which are not shown) depart, directed to each spray gun 26. In order to allow the correct movement of the pipes from the central portion of the rotating joint to the peripheral portions on which the spray guns 26 move, said tube-support chains 44 are used. For the sake of simplicity, in FIG. 4 only one tube-support chain 44 is shown, but naturally each gun 26 is provided with its own tube-support chain 44 when the guns 26 are twelve. Should the guns be twenty-four, the number of pipes is doubled and each tube-support chain 44 supports a double number of pipes. Downstream of the tube-support chain 44 the pair of tubes are divided and supply each its own gun.

FIG. 6 shows a tube-support chain 44 in an axonometric view. Each resting tube-support chain has an inverted U-shape, well visible in FIG. 6. During the rototranslation of guns 26, substantially the inverted U is distorted, wherein the two arms of the U are distanced from each other and at the same time the height of the inverted U is reduced.

FIG. 5 allows the shape modification of the tube-support chain 44 during spraying to be appreciated. The tube-support chain 44a is shown in a minimum extension position, corresponding to the view of FIG. 6; said tube-support chain 44a feeds the gun that is in a position near to the lesser axis of the oval. The tube-support chain 44b is shown in a maximum extent position; said tube-support chain 44b feeds the gun which is in the position corresponding to the greater axis of the oval moving chain 42. The tube-support chain 44c is shown in a position of intermediate extent between the two end positions 44a and 44b. During the movement along the oval trajectory, the two rotating supports 61 and 62, representing the two ends of each tube-support chain 44, move away and towards each other: this variation in distance is compensated by the different positions and shapes that the tube-support chain 44 can adopt, widening and tightening the two arms of the inverted U which form the tube-support chain 44 itself, and undergoing a corresponding reduction/increase in height.

Through the gearmotor 59 the moving chains 42 and the disc 56 are moved at the same time: a relative movement is generated between the two ends of the tube-support chain 44. During the gun movements, the rotating supports 61 and 62 move on two different trajectories: the rotating support 61 follows a circular trajectory on the disc 56, while the rotating support 62 follows an oval trajectory on the moving chains 42.

It is worthwhile highlighting that the tube-support chains have to move their mobile ends on their working plane only, in order to function properly. Otherwise, if the mobile ends of the tube-support chain 44 are moved on different planes, transverse loads are generated, which would lead to the breakage of the tube-support chain 44 itself. In the known art, such tube-support chains 44 normally are used to guide the movement of pipes or cables between two mobile ends that move on rectilinear and coplanar pathways. In this case, unlike the known art, the tube-support chain is used on a pathway provided with a rototranslation movement, provided with a rectilinear and a rotatory component.

It is worthwhile remembering that paint tends to settle, and therefore preferably the supply circuits of painting apparatuses are provided with a return branch to form a recirculation system keeping the paint in motion. As a consequence, the aforesaid number of pipes must be doubled, in order to dispose of a system of paint delivery and return.

The paint inlet branch goes from the paint storage reservoir (not shown) to a recirculating block 45 (visible in FIG. 6), while the paint return branch goes from the recirculating block 45 to the storage reservoir (not shown) which is placed outside the apparatus. Each gun 26 has its own recirculating block 45; in other words, the number of recirculating blocks 45 is equal to the number of spray guns 26. The end branch supplying paint, not undergoing recirculation, goes from the block 45 to the respective spray gun 26 thereof. The arm 41 supporting the gun located inside the spraying space; the diameter of the pipe of the latter branch has a section smaller than the rest of the circuit, so as to obtain a more compact gun support arm 41, which has a reduced exposed surface and therefore gets less dirty. All this reduces the probability that paint residues detach and fall on the transiting product 30.

A further feature of the rotating device 40 is that the whole device can be moved, moving the rotating device, and therefore the spray guns 26, to/from the transiting products 30 to be painted. All the device 40 is supported by two support columns 51, visible in FIG. 4. These columns 51 are supported by two lifting jacks 50, which are placed on the ground through support plates 52. This vertical movement occurs by working on said jacks 50 through a motor 53. The synchronous motion of the two jacks 50 is achieved through a drive shaft 54. In order to ensure suitable support for the device 40, the device 40 is guided through guiding systems 55 which are fixed to the conveying system of the products 30 to be painted.

FIG. 7 shows a detail of the oval rotating device 40 in a lateral view, i.e. from the short side of the oval, orthogonal to the view shown in FIG. 4.

FIG. 8 shows a detail of the spraying device in an axonometric view.

The two FIGS. 7 and 8 taken together allow the presence of a cleaning device 65 to be appreciated. This device 65 is known in the prior art, and is provided with a rotating brush 66, driven by a motor 67. This brush 66 is contained with its lower half inside a tray 68, containing the solvent or the detergent liquid.

This rotating brush has the object of cleaning the nozzles of the spray guns 26 when it is brought into a position that is such as to interfere with the gun 26.

During spraying, when spray guns 26 are active, said cleaning device 65 is in the resting position (lower position, shown in FIG. 7), distanced from the guns. At the end of a spraying cycle, the cleaning device 65 is automatically brought into its working position (top position) and can proceed to an automatic cleaning cycle of all the guns. Each gun 26 follows a tract of its oval path to be brought to the device 65, higher than it, and subsequently the cleaning device is raised. The nozzle of the gun undergoes brushing of a pre-set duration of some seconds (indicatively, from 5 to 10 seconds). Therefore, an automatic cleaning cycle has the duration of the pre-set cleaning time multiplied by the number of guns present. In an automatic cleaning cycle, all twelve or twenty-four guns present are cleaned.

The position of the cleaning device 65 is defined: in order to perform the cleaning of all the guns 26, the cleaning device 65 is raised until it is at the same height as the guns 26. The passage of a spray gun 26 to the following occurs while the cleaning device 65 is in the resting lower position, while when the following gun arrives at the cleaning device 65, the device 65 is lifted to the working position. In other words, during a cleaning cycle the cleaning device undergoes a number of translations upwards and downwards corresponding to the number of guns present. This translation movement occurs through a pneumatic cylinder 69, visible in FIG. 8.

Not all commercially available spray guns are identical, therefore adjusting means is provided to allow the correct positioning of the brush 66 with respect to the nozzle of the specific spray gun 26.

Finally, it is worthwhile specifying that in addition to the automatic cleaning working as explained above, also focused manual cleaning can be performed of the single spray gun 26.

Each spray gun 26 with the respective support arm 41 thereof is marked by a consecutive number, e.g. from one to twelve or from one to twenty-four, which allows the spray gun 26 to be identified univocally. For example, let us consider the case in which gun number eleven is spraying badly because the nozzle thereof is clogged. The apparatus 1 is provided with a program allowing the desired gun, e.g. said gun number eleven, to be taken to the greater axis of the oval. A human operator can remove the corresponding glass protection 6 and proceed to the manual cleaning of the nozzle of the gun number eleven.
1 apparatus
2 spray booth
3 chambers above the spray booth
4 air inlet group
5 air inlet hood
6 glass protection
7 tower for washing air
8 fans
9 exhaust flue
20 plenum
21 external descending portion
22 lateral parallel portion
23 central descending portion
24 central parallel portion
25 conveying belt
26 spray guns
27 suction tanks
28 tilted planes
29 suction channel
30 product to be painted
31 volume
32 volume
33 volume
34 separating baffle
35 separating baffle
36 external wall
37 volume above the rotating device
40 rotating device
41 spray gun support arm
42 moving chain
43 rotating joint
44 tube-support chain
45 recirculating block
50 jacks
51 columns
52 support plates
53 motor
54 drive shaft
55 guiding system
56 disc
57 motorized sprocket wheel
58 idle sprocket wheel
59 electric gearmotor
60 chain transmission
61 rotating support
62 rotating support
65 cleaning device
66 rotating brush
67 brush motor
68 tray
69 pneumatic cylinder

1. Apparatus (1) for applying paint, comprising a device (40) for applying paint comprising a plurality of spray guns (26) that are movable along a closed path having two parallel sides connected by two half circles, a rotating joint (43) for supplying paint provided with a distributor and comprising a plurality of tube-support chains (44), each tube-support chain (44) connecting the distributor of the one rotating joint (43) for dispensing the painting product to a respective gun of said spray guns (26), characterized in that each tube-support chain (44) has an inverted U-shape provided with two ends, of which
the first end is connected to a first rotating support (61), which is connected to the rotating disc (56) and in use follows a circular trajectory, while
the second end is connected to a second rotating support (62), which is connected to a support arm (41) of a respective gun (26) and follows in use the trajectory defined by said closed path.

2. Apparatus (1) according to claim 1, wherein said spray guns (26) are connected by the respective support arm (41) to a moving chain (42) that moves in use along a trajectory that is defined by said closed path, in which said chain (42) is supported by two columns (51), that in turn are supported by two raising jacks (50) which rest on the ground through respective support plates (52); acting on said jacks, it is possible to move moving chain (42) vertically, with the result that the spray guns (26) are moved to to/away from the products (30) to be painted, i.e. from the distributor of said rotating joint (43).

3. Apparatus (1) according to claim 1, wherein each spray gun (26) has a paint recirculating circuit, comprising an inlet branch going from a paint storage reservoir to a recirculating block (45), and a paint return branch going from said recirculating block (45) to the same paint storage reservoir placed outside the apparatus (1).

4. Apparatus (1) according to claim 3, wherein each spray gun (26) is connected to the moving chain (42) by a supporting arm (41) that has the paint inlet branch only, going from said recirculating block (45) to the spray gun (26).

5. Apparatus (1) according to claim 1, comprising a cleaning device (65), in turn comprising a rotating brush (66) half immersed inside a tray (68), said brush being driven by a motor (67).

6. Apparatus (1) according to claim 5, wherein said cleaning device (65) is drivable between two extreme positions:
a working position in which it interferes with spray guns (26) and
a resting position in which it does not interfere with spray guns (26);
the resting position allowing the translation of spray guns (26) both during the spraying and the cleaning operations.

7. Apparatus according to claim 5, wherein an automatic cleaning cycle is provided, wherein each gun (26) is taken to the cleaning device (65) and brushed for a pre-set time, the automatic cycle comprising the brushing time of each gun multiplied by the number of guns with which the carousel is provided.

8. Apparatus (1) according to claim 1, wherein the spray guns (26) are univocally identified, provided with a software program allowing a single desired gun to be brought to a transparent protection (6) of the spray booth (2), which is open by a human operator, so that said human operator can perform manual cleaning of said spray gun (26).

9. Apparatus (1) according to claim 1, wherein said device (40) for applying paint following a closed oval path having two parallel sides is used in combination with a plenum (20) of the spray booth provided with a symmetric M-shape comprising, from the respective periphery to the centre of the plenum:
two first descending surface portions (21) tilted towards the periphery;
two second lateral surface portions (22) parallel to the belt (25);
two third descending surface portions (23), having an inclination towards the centre, opposite that of the first portions (21);
a fourth central surface portion (24) parallel to said belt (25), which is closer to the conveying belt (25) than the lateral parallel portions (22).

10. Cleaning method of an apparatus according to claim 5, wherein an automatic cleaning cycle is provided, in which each spray gun (26) is taken to the cleaning device (65) and brushed for a preset time, the automatic cycle comprising the brushing time of each spray gun multiplied by the number of spray guns with which the rotating carousel is provided.

11. Cleaning method of an apparatus according to claim 1, wherein the spray guns are defined unequivocally, and a desired spray gun is
controlled by a software programme that enables the spray gun to be brought to a set position along the trajectory defined by the closed path so as to enable a manual cleaning operation of said spray gun by an operator.
